(19) United States
(12) Patent Application Publication
(10) Pub. No.: US 2007/0097398 A1
(43) Pub. Date: May 3, 2007

(54) Provision and use of device images that are associated with one or more relationships specifying how to navigate between the images

(76) Inventors: Andrew Christopher Walton, Rocklin, CA (US); Bryan J. Jacquot, Windsor, CO (US); Steve Lyle, Granite Bay, CA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/261,188

(22) Filed: Oct. 27, 2005

(51) Int. Cl. G06F 3/12

(52) U.S. Cl. 358/1.13

(57) ABSTRACT

In one embodiment, a device is provided with a non-volatile memory that stores a plurality of vector images illustrating different views of the device, and one or more relationships specifying how to navigate between the vector images. The device is also provided with an interface to provide access to the vector images. In another embodiment, a computer-implemented method includes: 1) retrieving at least a first image from a set of images stored in a device; 2) causing the first image to be displayed to a user; and 3) in response to the user's interaction with the first image, causing a second image retrieved from the device to be displayed to the user.

### BACKGROUND

The management of a device is typically aided by providing its user with a means to graphically visualize the device. In some cases, one or more images of a device and its components may be included within paper or electronic documentation (e.g., a user manual). In other cases, a device may be provided with stickers showing one or more views of the device's interior components.

In still other cases, images of a device may be incorporated into a management tool for the device. For example, a print driver may display an image of the printer to which it corresponds, or a server management tool may display various images associated with the server components of which the management tool is aware or can manage (e.g., the server's memory modules, interfaces, or storage disks).

Many devices for which graphical images are needed are subject to change. That is, the devices may be upgradeable such that additional components (e.g., memory modules, interfaces, or storage disks) may be inserted into or attached to the device. Thus, an issue facing the image creator is whether to draw an image of each configuration of the device or draw a single “exemplary” image in which the device is depicted in one particular “default” configuration.

A device may also be subject to change over its lifecycle. That is, the styling of the device's exterior, the suppliers of its internal components, its “default” configuration, and even its available features can change over its lifecycle. Thus, any images pertaining to the first generation of the device may not accurately depict later generations of the device.

As one can appreciate, the creation and maintenance of graphical images for a device can present a significant burden for both device manufacturers and third-party device supporters (e.g., management tool developers).

### SUMMARY OF THE INVENTION

In one embodiment, a device comprises a non-volatile memory that stores a plurality of vector images illustrating different views of the device, and one or more relationships specifying how to navigate between the vector images. The device also comprises an interface to provide access to the vector images.

In another embodiment, a computer-implemented method comprises 1) retrieving at least a first image from a set of images stored in a device, the first image illustrating at least a portion of the device; 2) causing the first image to be displayed to a user; and 3) in response to the user's interaction with the first image, causing a second image retrieved from the device to be displayed to the user.

In yet another embodiment, a computer program comprises 1) code to retrieve at least a first image from a set of images stored in a device, the first image illustrating at least a portion of the device; 2) code to display the first image to a user; and 3) code to, in response to the user's interaction with the first image, display a second image retrieved from the device to the user.

In another embodiment, an article of manufacture comprises computer-readable media, and computer-readable code that is stored on the computer-readable media. The computer-readable code includes: 1) code to retrieve at least a first image from a set of images stored in a device, the first image illustrating at least a portion of the device; 2) code to display the first image to a user; and 3) code to, in response to the user's interaction with the first image, display a second image retrieved from the device to the user.

Other embodiments are also disclosed.

### BRIEF DESCRIPTION OF THE DRAWINGS

Illustrative embodiments of the invention are illustrated in the drawings, in which:

FIG. 1 illustrates an exemplary device having an image embedded therein;

FIGS. 2 & 3 illustrate exemplary graphical representations of two of the images that are embedded in the FIG. 1 device; and

FIG. 4 illustrates an exemplary computer-implemented method for accessing the images stored in the FIG. 1 device.

### DETAILED DESCRIPTION

One development that has eased the burden of creating and maintaining graphical images for a device is the electronic storage of a device's images within the device itself. For example, different images pertaining to different views and/or components of a device may be saved as Scalable Vector Graphics (SVG) files, or as other easy-to-manipulate files, and stored within a non-volatile memory of the device. Thus, a management tool for the device no longer needs to provide its own set of images for the device. Rather, the management tool need only be provided with abilities to 1) query the device to retrieve its image set, and 2) format one of the images to reflect the current state of the device. In this manner, the developer of the management tool need not be concerned with how the device looks, and can instead focus on how the device functions and is managed.

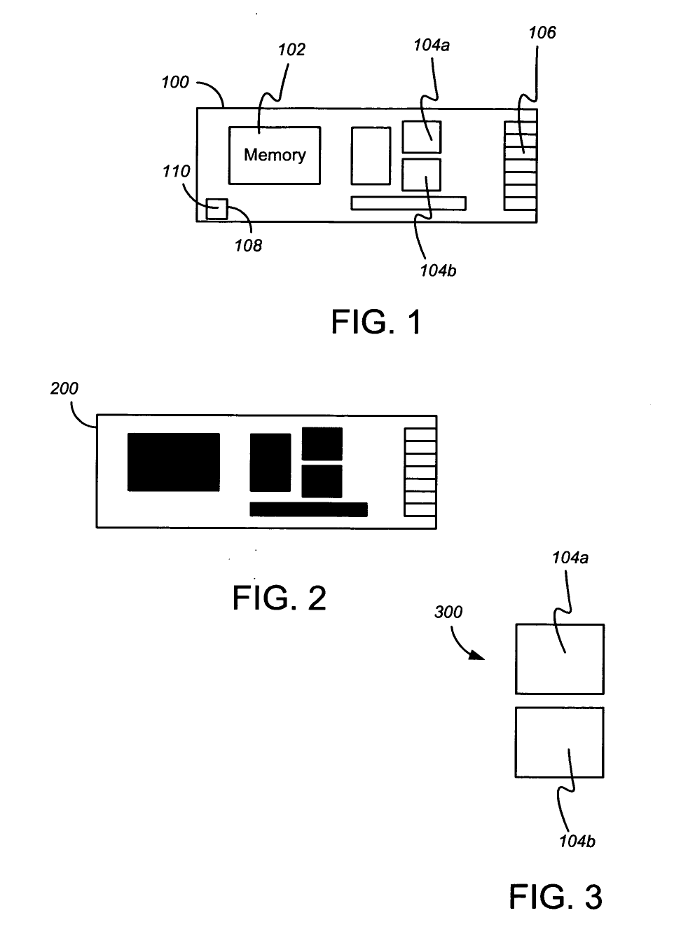

FIG. 1 illustrates an exemplary device 100. By way of example, the device 100 is shown to be a motherboard comprising a memory bank 102, a pair of processors 104a, 104b, and an interface 106. However, the methods and apparatus disclosed herein may be applied to any device, including those that form components of systems (such as the motherboard 100, an accessory card, or a memory module), and those that are fully functional systems and possibly contain other devices (e.g., servers, storage devices, printers or facsimile machines).

Stored within a non-volatile memory of the device 100 is a set of images 110 that illustrate different views of at least a portion of the device 100. In one embodiment, the images 110 are vector images, such as Scalable Vector Graphics (SVG) or other (extensible Markup Language) XML-based images. However, the images 110 could take other forms, such as postscript images.

The memory that stores the images 110 may be a memory that is used for other functions of the device 100 (e.g., the memory 102), or a memory 108 that is dedicated to storing images 110 of the device 100 or providing some subset of functionality for the device 100.

The device 100 also comprises an interface to provide access to the images 110. In some cases, the interface may be an interface that is used for other functions of the device 100 (e.g., the interface 106), and in other cases, the interface may be a dedicated interface (not shown).

Two exemplary ones of the images 110 are respectively illustrated in FIGS. 2 & 3. The image 200 illustrates the device 100 as a whole, whereas the image 300 illustrates a “zoom” view of the device's processors 104a, 104b.

In addition to storing a plurality of images 110 in the device 100, one or more relationships specifying how to navigate between the images 110 may be stored in the device 100. In this manner, a device's images 110, as well as their relationship(s), are stored in the device 100 to which they relate.

In one embodiment, the one or more relationships that specify how to navigate between images are embedded in the images themselves. For example, one or more navigation tags may be embedded in the images, with each of the navigation tags linking to another of the vector images. If the images are SVG or other XML-based images, the navigation tags may take the form of XML tags.

In some cases, a navigation tag may be associated with only a portion of a vector image (e.g., a component, a removable unit, or a region of a vector image). A user's selection of the image portion may then be correlated with the navigation tag, and an image to which the navigation tag links (e.g., an exploded or alternate view of the image portion) may be displayed. In other cases, a navigation tag may be associated with an image navigation cue, such as: an image map having selectable areas, a clickable button that is labeled with an image identifier, a clickable arrow (e.g., for selecting a top, bottom or side view of that which is currently shown), a “zoom in” or “zoom out” button, a menu selection, or fly-over text that is displayed when a graphical pointer hovers over a portion of a displayed image. The image navigation cues are preferably stored within the images themselves. However, the image navigation cues may sometimes be provided as image overlays, or by management tools that display the images (e.g., as part of menus or toolbars displayed by the management tools).

In another embodiment, the one or more relationships that specify how to navigate between images are defined by an application programming interface (API) stored within the device 100 (e.g., within the memory 108). In this embodiment, navigation tags stored within a device's images, or user clicks on a displayed image (or menus or icons that are associated with the image), are passed to the API. Image relationships maintained by the API are then accessed to determine whether a different image should be displayed to the user. Similarly to the embedded navigation tags described previously, the API may link portions of an image (or displayed navigation cues) to other images.

The images 110 that are stored within a device 100 may be related in various ways. In some cases, the images 110 may be related as systems and subsystems (e.g., components), and the relationships that specify how to navigate between them may specify paths for drilling up and down through the images. See, for example, the “device view” 200 and “processor view” 300 shown in FIGS. 2 & 3.

Alternately, or additionally, the images 110 stored in a device may be related as alternate views of the device (or a portion of the device). For example, the images may comprise assembled and exploded views, or any or all of: front, back, top, bottom or side views. In this case, the relationships that specify how to navigate between the images may relate these alternate views.

A device's images may also comprise physical and logical views, and relationships that specify how to navigate between these views.

In addition to storing relationships that specify how to navigate between a device's images 110, a device 100 may identify one or more of its images as providing default views. For example, one of a device's images may be identified as a default view of the device. In this manner, a request for an image “of the device” may be fulfilled by returning the image that provides the default view. Alternately, or additionally, different ones of a device's images may be identified as providing default views for different subsystems (e.g., components) of the device. Each of the default images may provide a default entry point into an image navigation structure that is defined by the one or more relationships that specify how to navigate between the device's images.

By labeling certain images as default views, a management tool that is designed to manage only a particular aspect of a device (e.g., memory) can request an image of the relevant portion of a device, instead of requesting an image for the device (e.g., a server in which the memory resides) “as a whole”.

The default image(s) for a device may be identified in various ways. For example, they may be identified by tags or other indicators stored within a device's various image files 110. Or, for example, the default images may be identified by their respective filenames.

A device's images 110 may also be associated with additional navigation information. For example, a device's images 110 may comprise tags, filenames or other items that generally indicate which views the images represent, such as tags indicating “back”, “front”, “top”, “bottom”, “side”, “plan”, “perspective” or “exploded” views.

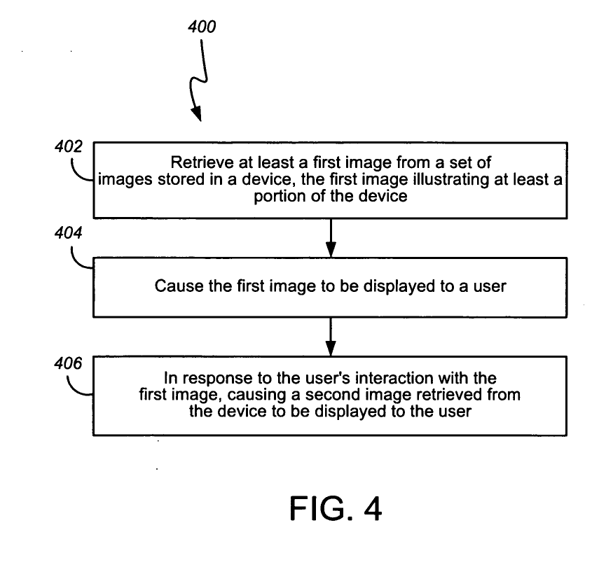

FIG. 4 illustrates an exemplary computer-implemented method 400 for accessing the images 110 stored in the device 100. In accord with the method 400, at least a first image is retrieved 402 from the set of images 110 stored in the device 100. In one embodiment, the image is retrieved in response to an image request; and the image is identified based on one or more “default view indicators”, each of which is associated with one of the images stored in the device. If the image request does not specify a desired view of the device, the default view indicators may be parsed to identify a default image for the device. However, if the image request does specify a desired view, the desired view may be compared to the default view indicators to identify an image associated with a default view corresponding to the desired view.

After retrieving the first image, the method 400 causes 404 the first image to be displayed to a user. In some cases, this may involve actually displaying the image. In other cases, “causing” the image to be displayed may simply involve passing the image to another program or device for display.

In one embodiment, causing the image to be displayed comprises causing an image navigation cue embedded within the first image to be displayed. The image navigation cue may be associated with a navigation tag that links to a second image retrieved from the device.

After display of the first image, a user may interact with the first image. In response to this interaction, a second image retrieved from the device is caused 406 to be displayed to the user. In some cases, this is done by 1) correlating the user's interaction with a navigation tag embedded in the first image, and then 2) identifying the second image based on the navigation tag. In other cases, the second image is caused to be displayed by, in response to the user's interaction with the first image, accessing an application programming interface (API) of the device to identify the second image.

In one embodiment of the method 400, the first and second images are separately retrieved from the device. In another embodiment, all of the device's images are retrieved at the same time and stored in off-device storage. The second image is then retrieved for display from the off-device storage.

The method 400 may be implemented via a computer program, in which code (e.g., firmware or software) is executed to perform the various steps of the method 400. The code may be stored on various computer-readable media, including fixed or removable media (such as one or more fixed disks, random access memories (RAMs), read-only memories (ROMs) or compact discs) at either a single location or distributed over a network. In some cases, the program may be incorporated into a particular device management tool. In other cases, the program may be maintained apart from any particular device management tool (e.g., within an image processing utility) and may be accessed by various device management tools. By way of example, the “utility” may take the form of an application or browser plug-in.

The above-described methods and apparatus are useful, in one respect, in that they provide a means for navigating between different images of a device. In addition, they can eliminate the hard-coding of image navigation information into device management tools. This not only makes management tools more flexible (i.e., they can be used with more than one device), but it also makes it easier to manage device images and their relationships, as they are stored together in the devices to which they pertain, and apart from the tools for managing the devices.

What is claimed is:

1. A device, comprising:
a non-volatile memory storing i) a plurality of vector images illustrating different views of at least a portion of the device, and ii) one or more relationships specifying how to navigate between the vector images; and
an interface to provide access to the vector images.

2. The device of claim 1, wherein the one or more relationships are embedded in the vector images.

3. The device of claim 2, wherein at least one of the vector images comprises an image navigation cue for display to a user, the image navigation cue being associated with a navigation tag that links to a second of the vector images.

4. The device of claim 1, wherein a first of the vector images comprises an embedded navigation tag that links a portion of the vector image to a second of the vector images.

5. The device of claim 4, wherein the portion of the vector image linked to the second of the vector images is a removable unit of the device.

6. The device of claim 1, wherein the one or more relationships are defined by an application programming interface (API).

7. The device of claim 1, wherein at least one of the vector images comprises an image navigation cue for display to a user, the image navigation cue being associated with a navigation tag that links to a second of the vector images.

8. The device of claim 7, wherein at least one of the navigation cues comprises fly-over text.

9. The device of claim 1, wherein the one or more relationships specify one or more paths for drilling up/down through the vector images.

10. The device of claim 1, wherein the one or more relationships relate alternate views of at least a portion of the device.

11. The device of claim 1, wherein the one or more relationships relate physical and logical views of at least a portion of the device.

12. The device of claim 1, wherein a first of the images is identified as providing a default view of the device, and wherein the first image provides a default entry point into an image navigation structure defined by the one or more relationships that specify how to navigate between the vector images.

13. The device of claim 12, wherein the first image is identified by its filename.

14. The device of claim 1, wherein different ones of the images are identified as providing default views for different subsystems of the device, and wherein the images that provide default views provide various entry points into an image navigation structure defined by the one or more relationships that specify how to navigate between the vector images.

15. The device of claim 14, wherein the images are identified by their respective filenames.

16. A computer-implemented method, comprising:
retrieving at least a first image from a set of images stored in a device, the first image illustrating at least a portion of the device;
causing the first image to be displayed to a user; and
in response to the user's interaction with the first image, causing a second image retrieved from the device to be displayed to the user.

17. The method of claim 16, wherein the images are vector images.

18. The method of claim 16, further comprising:
correlating the user's interaction with a navigation tag embedded in the first image; and
identifying the second image based on the navigation tag.

19. The method of claim 16, further comprising, in response to the user's interaction with the first image, accessing an application programming interface (API) of the device to identify the second image.

20. The method of claim 16, further comprising:
retrieving the first image in response to an image request that specifies a desired view; and
identifying the first image by comparing the desired view type to one or more view type indicators, each of which is associated with one of the images in the set of images.

21. The method of claim 16, further comprising:
retrieving the first image in response to an image request; and
identifying the first image based on one or more default view indicators, each of which is associated with one of the images in the set of images.

22. The method of claim 16, wherein causing the first image to be displayed comprises causing an image navigation cue that is embedded within the first image to be displayed; the image navigation cue being associated with a navigation tag that links to the second image.

23. The method of claim 16, wherein the first image is retrieved while retrieving the set of images; the method further comprising:
storing the set of images in off-device storage; and
retrieving the second image for display from the off-device storage.

24. A computer program, comprising:
code to retrieve at least a first image from a set of images stored in a device, the first image illustrating at least a portion of the device;
code to display the first image to a user; and
code to, in response to the user's interaction with the first image, display a second image retrieved from the device to the user.

25. An article of manufacture, comprising:
computer-readable media; and
computer-readable code, stored on the computer-readable media, including:
code to retrieve at least a first image from a set of images stored in a device, the first image illustrating at least a portion of the device;
code to display the first image to a user; and
code to, in response to the user's interaction with the first image, display a second image retrieved from the device to the user.
